(19) United States
(12) Patent Application Publication
(10) Pub. No.: US 2024/0388403 A1
(43) Pub. Date: Nov. 21, 2024

(54) METHODS, NETWORK NODE AND USER EQUIPMENT FOR CONTROLLING TRANSMISSION OF UPLINK APERIODIC SOUNDING REFERENCE SIGNALS

(71) Applicant: Telefonaktiebolaget LM Ericsson (publ), Stockholm (SE)

(72) Inventor: Ping WU, Stockholm (SE)

(21) Appl. No.: 18/693,230

(22) PCT Filed: Sep. 21, 2021
(86) PCT No.: PCT/SE2021/050909

§ 371 Date: Mar. 19, 2024

(51) Int. Cl. H04L 5/00

(52) U.S. Cl. CPC H04L 5/0051; H04L 5/0037

(57) ABSTRACT

A method by a network node controls transmission of uplink APeriodic Sounding Reference Signals, AP-SRS. Sending to UEs in a same cell an AP-SRS configuration message comprising an offset corresponding to each UE. The offset defining after how many time slots from receiving a trigger signal each UE should transmit the AP-SRS. Prioritizing the UEs being triggered by the trigger signals in accordance with the sent corresponding offset.

### TECHNICAL FIELD

The present disclosure relates generally to methods, network nodes of wireless communication network and user equipment (UE) for controlling transmission of uplink aperiodic sounding reference signals (AP-SRS) in a wireless communication network. The present disclosure further relates to computer programs and carriers corresponding to the methods, nodes and UE.

### BACKGROUND

To meet the huge demand for higher bandwidth, higher data rates and higher network capacity, due to e.g., data centric applications, existing 4th Generation (4G) wireless communication network technology, aka Long Term Evolution (LTE) is being extended or enhanced into a 5th Generation (5G) technology, also called New Radio (NR) access. The following are requirements for 5G wireless communication networks:
Data rates of several tens of megabits per second should be supported for tens of thousands of users;
1 gigabit per second is to be offered simultaneously to tens of workers on the same office floor;
Several hundreds of thousands of simultaneous connections are to be supported for massive sensor deployments;
Spectral efficiency should be significantly enhanced compared to 4G;
Coverage should be improved;
Signaling efficiency should be enhanced; and
Latency should be reduced significantly compared to 4G.

Massive Multiple Input Multiple Output (MIMO) is one of the most important technologies used in both LTE and NR because of its remarkable spatial multiplexing gain and powerful interference cancelation ability.

For single user (SU) and multiple user (MU) downlink MIMO, channel reciprocity is utilized to calculate SU or MU downlink beamforming weight, which can suppress both the intra-cell and inter-cell interferences.

In terms of channel reciprocity utilization, a sounding reference signal (SRS) is the key uplink resource to be used for SU and MU downlink beamforming. The SRS is a reference signal transmitted by the UE in the uplink direction, which is used by the network node, e.g. eNB in LTE or gNB in NR, to estimate the uplink channel quality over a wider bandwidth. Due to channel reciprocity, the estimated channel quality can also be applied to the downlink channel.

There are 3 different types of SRS, i.e., periodic SRS (P-SRS), semi-persistent SRS (SP-SRS) and aperiodic SRS (AP-SRS). The P-SRS is configured by Radio Resource Control (RRC) messaging, then UE periodically sends SRS without further triggering, which is the most static type. The SP-SRS is also configured by RRC messaging, then eNB or gNB activates or deactivates the SP-SRS by a Media Access Control (MAC) control element. The UE will send the SP-SRS periodically if it is activated and stop sending SP-SRS after deactivation command being received. SP-SRS is more flexible than P-SRS.

AP-SRS is even more flexible than SP-SRS and P-SRS because it is configured by a RRC message and then triggered by a Downlink Control Indicator (DCI) on demand.

FIG. 1 shows a typical message sequence chart for AP-SRS configuration and triggering, i.e., from a network node, here exemplified with a gNB 10, to a wireless device, called UE 20, in 5G networks. The gNB 10 transmits 1.1 an AP-SRS configuration message as an RRC message to the UE 20. The configuration message comprises an offset for corresponding UE 20. The offset indicates a number of time slots, which means the UE 20 will transmit an AP-SRS to the gNB 20 after the number of time slots upon receiving a trigger signal from the gNB 10. When it is time for triggering the UE to transmit an AP-SRS, the gNB 10 transmits 1.2 a triggering signal as a DCI to the UE 20 for triggering the AP-SRS procedure. When receiving, the DCI, the UE 20 will wait for a time period corresponding to the offset, then the UE 20 sends 1.4 an AP-SRS to the gNB 10.

However, it has been observed in networks today that the triggering of AP-SRS often fails. That is, even if the UE is scheduled in a TTI, the gNb or eNb fails to send the AP-SRS triggering signal because the stipulated AP-SRS sending TTI for UE is the current TTI plus the configured AP-SRS offset, but the stipulated AP-SRS sending TTI is not a potential SRS TTI. Consequently, there is a need of a process for securing that AP-SRS can be sent from a UE at the stipulated time set in the offset, so as to improve the triggering possibility and control the transmission of uplink AP-SRS.

### SUMMARY

It is an object of the invention to address at least some of the problems and issues outlined above. It is possible to achieve these objects and others by using the method, network node and wireless communication devices as defined in the attached independent claims.

According to one aspect, a method performed by a network node of a wireless communication network, for controlling transmission of uplink APeriodic Sounding Reference Signals, AP-SRS, the method comprising: sending, to each of a plurality of User Equipment, UE, an AP-SRS configuration message comprising at least one offset corresponding to each UE, said offset defining after how many time slots from receiving a trigger signal each of the plurality of UEs should transmit the AP-SRS, said plurality of UEs being in one and same cell; prioritizing, the plurality of UEs being triggered by the trigger signals in accordance with the sent corresponding offset, thus a UE of the plurality of UEs being prioritized, UE U_{Li}, being triggered in a valid AP-SRS triggering slot, said valid AP-SRS triggering slot is a time slot that if the trigger signal is sent to the UE U_{Li} in this slot, the UE U_{Li} will send an AP-SRS after its corresponding offset, the AP-SRS sending slot of the UE U_{Li} is an SRS slot; sending, to each of the plurality of UEs, trigger signals at time slots that are equal to the number of time slots before the AP-SRS is to be transmitted by an individual UE of the plurality of UEs; wherein the trigger signals instructing each of the plurality of UEs to transmit the AP-SRS in a time slot after its corresponding offset.

According to another aspect, A method performed by a User Equipment UE for receiving wireless signals from a network node of a wireless communication network, the method comprising: receiving, from the network node, an AP-SRS configuration message comprising at least one offset defining after how many time slots from receiving a trigger signal the UE should transmit the AP-SRS; receiving, from the network node, a trigger signal at a time slot that is equal to the number of time slots before the AP-SRS is to be transmitted, said number of time slots being defined in the received offset; and sending, an AP-SRS to the network node in a time slot that is equal to the number of time slots after receiving the trigger signal from the network node, said number of time slots being defined in the offset comprised in the received AP-SRS configuration message.

According to another aspect, a network node operable in a wireless communication network, and configured for controlling transmission of uplink APeriodic Sounding Reference Signals, AP-SRS, the network node comprising a communication unit, a processing circuitry and a memory, said memory containing instructions executable by said processing circuitry, whereby the network node is operative for: sending, to each of a plurality of User Equipment, UE, an AP-SRS configuration message comprising at least one offset corresponding to each UE, said offset defining after how many time slots from receiving a trigger signal each of the plurality of UEs should transmit the AP-SRS, said plurality of UEs being in one and same cell; prioritizing, the plurality of UEs being triggered by the trigger signals in accordance with the sent corresponding offset, thus a UE of the plurality of UEs being prioritized, UE U_{Li}, being triggered in a valid AP-SRS triggering slot, said valid AP-SRS triggering slot is a time slot that if the trigger signal is sent to the UE U_{Li}, the UE U_{Li} will send an AP-SRS after its corresponding offset, the AP-SRS sending slot of the UE U_{Li} is an SRS slot; sending, to each of the plurality of UEs, trigger signals at time slots that are equal to the number of time slots before the AP-SRS is to be transmitted by an individual UE of the plurality of UEs; wherein the trigger signal instructing each of the plurality of UEs to transmit AP-SRS in a time slot after its corresponding offset.

According to another aspect, a User Equipment UE operable in a wireless communication network and configured for receiving wireless signals from a network node of the wireless communication network, the UE comprising a processing circuitry and a memory, said memory containing instructions executable by said processing circuitry, whereby the UE is operative for: receiving, from the network node, an AP-SRS configuration message comprising at least one offset defining after how many time slots from receiving a trigger signal the UE should transmit the AP-SRS; receiving, from the network node, a trigger signal at a time slot that is equal to the number of time slots before the AP-SRS is to be transmitted, said number of time slots being defined in the received offset; and sending, an AP-SRS to the network node in a time slot that is equal to the number of time slots after receiving the trigger signal from the network node, said number of time slots being defined in the offset comprised in the received AP-SRS configuration message.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a signaling diagram of an AP-SRS triggering procedure between a network node and a device.

FIG. 2 is a schematic block diagram of a wireless communication network in which the present invention may be implemented.

FIG. 3 is a schematic block diagram of a frame structure of an example of AP-SRS triggering schedule.

FIG. 4 is a schematic block diagram of a frame structure of an example of AP-SRS triggering successful and failure.

FIG. 5 is a flow chart illustrating a method performed by a network node, according to exemplary embodiments.

FIG. 6 is another flow chart illustrating an exemplary embodiment of the method performed by a network node.

FIG. 7 is a schematic block diagram of example of a subset L being utilized in the method performed by a network node.

FIG. 8 is a block diagram illustrating a prioritizing procedure of a plurality of UEs according to according to exemplary embodiments.

FIG. 9 is a schematic block diagram of a frame structure of an example of a successful AP-SRS triggering schedule.

FIG. 10 is a flow chart illustrating a method performed by a UE, according to exemplary embodiments.

FIG. 11 is a block diagram illustrating a network node in more detail, according to further possible embodiments.

FIG. 12 is a block diagram illustrating a UE in more detail, according to further possible embodiments.

### DETAILED DESCRIPTION

FIG. 2 shows a wireless communication network 100 comprising a network node 130 that is in, or is adapted for, wireless communication with a number of wireless devices 140, 142, . . . 148, i.e., UEs. The network node 130 provides radio coverage in a cell 150, which can be interpreted as a geographical area. The number of wireless devices 140, 142, . . . 148 shown in FIG. 2 reside in the cell 150.

The wireless communication network 100 may be any kind of wireless communication network that can provide radio access to wireless communication devices. Example of such wireless communication networks are Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE) Frequency Division Duplex (FDD) and Time Division Duplex (TDD), LTE Advanced, Wireless Local Area Networks (WLAN), Worldwide Interoperability for Microwave Access (WiMAX), WiMAX Advanced, as well as 5G wireless communication networks based on technology such as New Radio (NR). However, the embodiments of the following detailed description are described for NR.

The network node 130 may be any kind of network node that provides wireless access to the number of wireless devices 140, 145 alone or in combination with another network node. The network node may also be called radio network node. Examples of a network node 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH), nodes in a distributed antenna system (DAS) and a multi-standard radio BS (MSR BS).

The wireless devices 140, 142, . . . 148 may be any type of device capable of wirelessly communicating with a network node 130 using radio signals. The wireless devices may also be called wireless communication devices or simply devices in this disclosure. For example, the wireless devices 140, 142, . . . 148 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

The embodiments described herein may be applicable to single carrier as well as to multicarrier (MC) or carrier aggregation (CA) operation of the wireless devices. The term carrier aggregation (CA) may also be called multi-carrier system, multi-cell operation, multi-carrier operation, and multi-carrier transmission and/or reception. The embodiments may equally apply for Multi radio bearers (RAB) on some carriers, which means that data and speech are simultaneously scheduled.

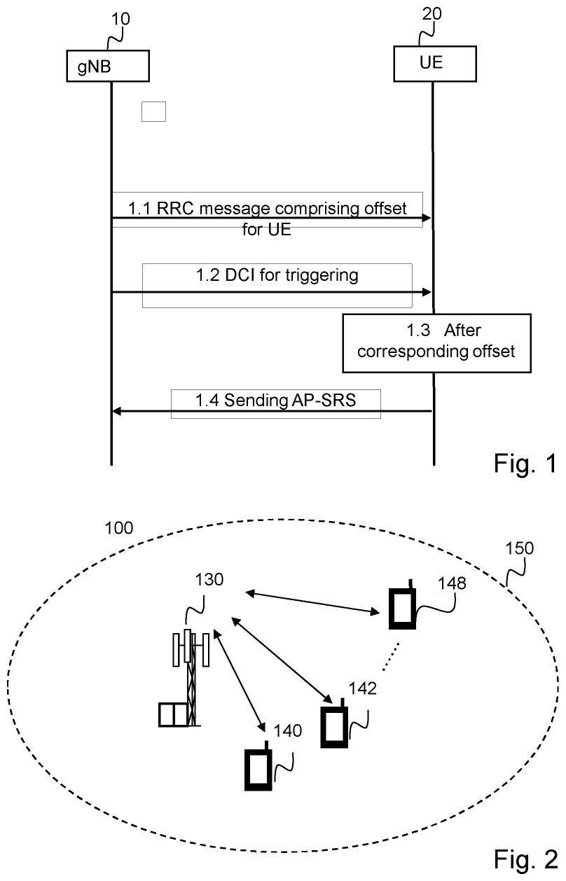

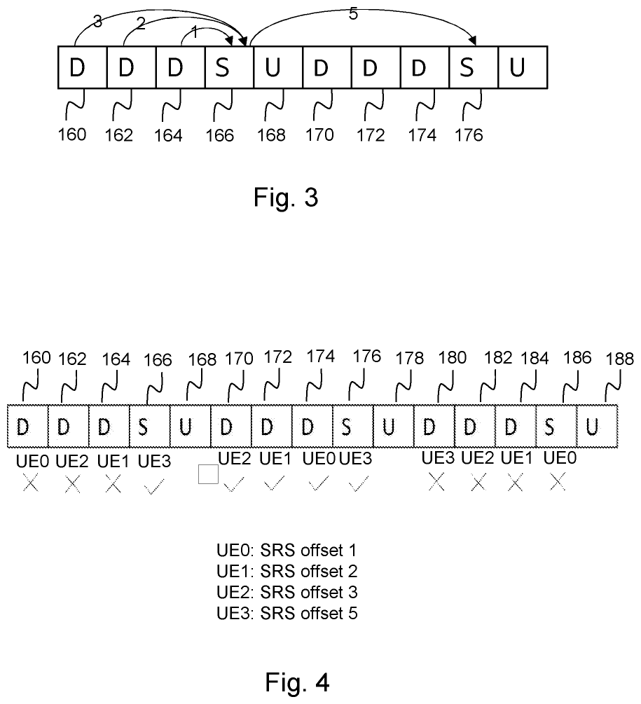

The network node 130 and each one of the UEs 140, 142, . . . 148 within one cell 150 will perform the procedure described in FIG. 1. FIG. 3 shows a frame structure which illustrates the triggering schedule. For example, if a trigger signal is transmitted to a UE in downlink slot 160, and the UE is configured with an offset 3, then the UE will send its AP-SRS in slot 166, which is an SRS slot. Similarly, if a trigger signal is transmitted to a UE in downlink slot 162, and the UE is configured with an offset 2, the UE will send its AP-SRS in SRS slot 166. The SRS slot can also be utilized to transmit a trigger signal. If the trigger signal is transmitted to the UE in the SRS slot 166, and the UE is configured with an offset 5, the UE will send its AP-SRS in SRS slot 176.

However, if the AP-SRS is not scheduled to be sent in an SRS slot, the triggering becomes a failure. In other words, the AP-SRS can only be transmitted in an SRS slot, which is dedicated for transmitting uplink AP-SRS for UEs. FIG. 4 shows a frame structure which illustrates examples of triggering success and failure. UE0 is triggered in downlink slot 160, however, since its configured offset is 1, the AP-SRS is scheduled to be sent in downlink slot 162. However, the downlink slot 162 is not an SRS slot for transmitting uplink AP-SRS, the triggering of UE0 is not successful. Thus the slot 160 is not a valid AP-SRS triggering slot for UE0. Similarly, if UE2 is triggered in downlink slot 162, considering corresponding offset 3, the AP-SRS is scheduled to be sent in slot 168, which is not an SRS slot either. Thus the triggering of UE2 is also a failure and the slot 162 is not a valid AP-SRS triggering slot for UE2. UE3 is being triggered in slot 166, its AP-SRS is scheduled to be sent in SRS slot 176 according to its offset 5. Since the SRS slot 176 is a valid slot for transmitting AP-SRS, UE3 is successfully triggered in slot 166, and the slot 166 is a valid AP-SRS triggering slot for UE3. Among the four UEs, only one UE UE3 is successfully triggered, and the triggering possibility is quite low, thereby the SRS processing capability cannot be fully utilized, and the reciprocity gain also becomes low.

Therefore, there is a need for a method adjust the UEs to right triggering slots, so that the corresponding AP-SRS sending slot can be the dedicated SRS slot, such as slots 166 and 176 in FIG. 3.

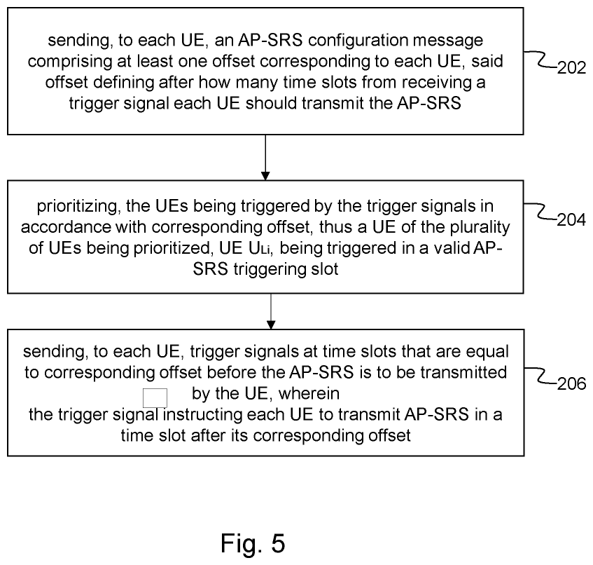

FIG. 5 discloses a method performed by a network node 130 of a wireless communication network 100, for controlling transmission of uplink APeriodic Sounding Reference Signals (AP-SRS). The method comprises sending 202, to each of a plurality of UE 140, 142, 148, an AP-SRS configuration message comprising at least one offset corresponding to each UE, said offset defining after how many time slots from receiving a trigger signal each of the plurality of UEs 140, 142, 148 should transmit the AP-SRS, said plurality of UEs 140, 142, 148 being in one and same cell 150. The method further comprises prioritizing 204, the plurality of UEs 140, 142, 148 being triggered by the trigger signals in accordance with the sent corresponding offset, thus a UE of the plurality of UEs 140, 142, 148 being prioritized, UE U_{Li}, being triggered in a valid AP-SRS triggering slot, said valid AP-SRS triggering slot is a time slot that if the trigger signal is sent to the UE U_{Li} in this slot, the UE U_{Li} will send an AP-SRS after its corresponding offset, the AP-SRS sending slot of the UE U_{Li} is an SRS slot. The method further comprises sending 206, to each of the plurality of UEs 140, 142, 148, trigger signals at time slots that are equal to the number of time slots before the AP-SRS is to be transmitted by an individual UE of the plurality of UEs 140, 142, 148, wherein the trigger signals instructing each of the plurality of UEs 140, 142, 148 to transmit the AP-SRS in a time slot after its corresponding offset.

By such a method, the network node 130 triggers the transmission of AP-SRS, and the UEs 140, 142, 148 according to received trigger signal and offset. Since the UEs are being prioritized then triggered in a valid AP-SRS triggering slot, their corresponding AP-SRS are scheduled to be sent in dedicated SRS slots, such as SRS slots 166 and 176 in FIG. 3. Thus the UEs can sent AP-SRS on demand and being scheduled in a proper way, the whole system is more flexible, and the triggering possibility is increased significantly.

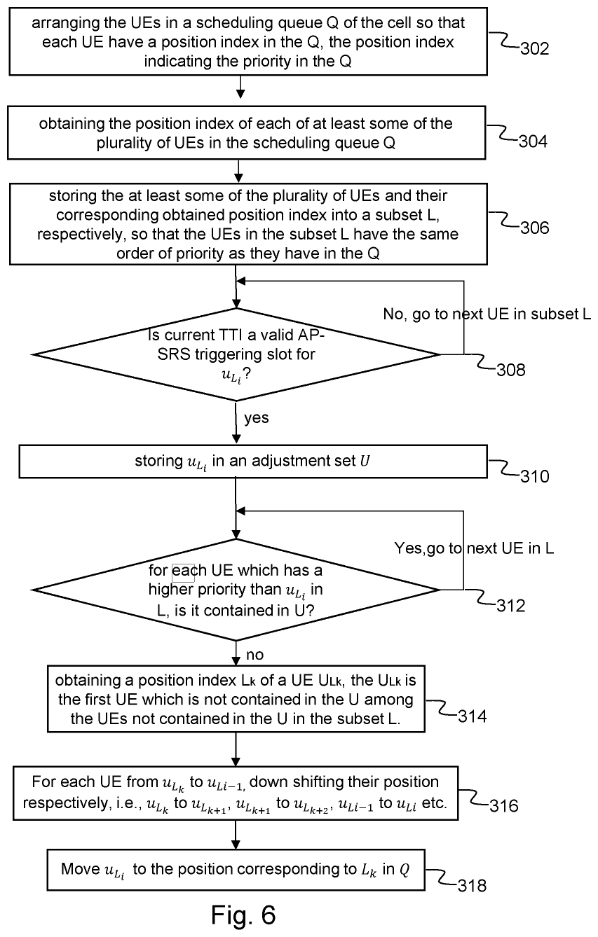

According to another embodiment in FIG. 6, the prioritizing 204 of the plurality of UEs 140, 142, 148 being triggered by the trigger signals in accordance with the sent corresponding offset further comprises: arranging 302 the plurality of UEs 140, 142, 148 in a scheduling queue Q of the cell 150 so that each UE of the plurality of UEs 140, 142, 148 has a certain position with a certain position index in the queue, the position index indicating the priority in the scheduling queue Q of the corresponding UE; obtaining 304 the position index of each of at least some of the plurality of UEs 140, 142, 148 in the scheduling queue Q; storing 306 the at least some of the plurality of UEs 140, 142, 148 and their corresponding obtained position index into a subset L, respectively, so that the UEs in the subset L have the same order of priority as they have in the scheduling queue Q; determining 308, for each UE in the subset L, if a current Transmission Time Interval TTI is a valid AP-SRS triggering slot for the UE U_{Li}, wherein Li is the position index of the UE U_{Li} in the scheduling queue Q; if yes, storing 310 the UE U_{Li} in a priority adjustment set U; for each UE which has a higher priority than the UE U_{Li} in the subset L, determining 312 if the UE is already contained in the priority adjustment set U; among the UEs determined not to be contained in the priority adjustment set U, obtaining 314 a position index Lₖ of a UE U_{Lk}, wherein the UE U_{Lk} is the first UE which is not contained in the priority adjustment set U among the UEs determined not to be contained in the priority adjustment set U in the subset L; for each UE from said first UE U_{Lk} to UE U_{Li-1}, down shifting 316 their position in the scheduling queue Q, respectively, wherein down shift means moving each UE from said UE U_{Lk} to UE U_{Li-1} respectively, to the position of the next UE in the subset L, for example, UE U_{Lk} to the position of UE U_{Lk+1}, UE U_{Lk+1} to the position of UE U_{Lk+2}, UE U_{Li-1} to the position of UE U_{Li}, said UE U_{Li-1} having higher priority than the UE U_{Li} and having least priority difference to the UE U_{Li} in the subset L; moving 318 the UE U_{Li} to a position corresponding to the position index Lₖ in the scheduling queue Q.

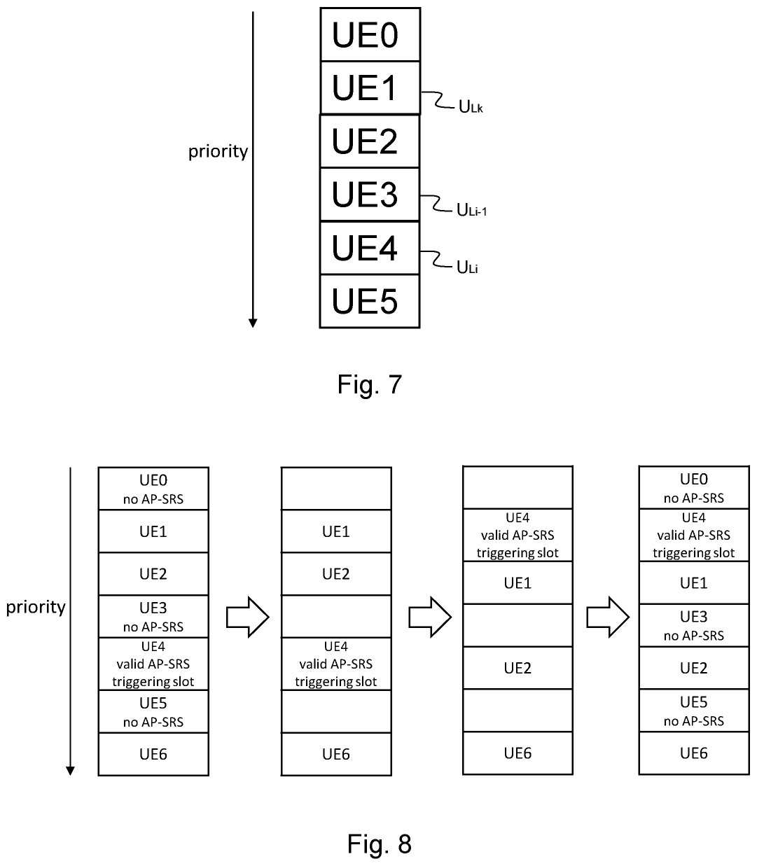

Referring to FIG. 6 in conjunction with FIG. 7, when prioritizing 204 the UEs, a scheduling queue Q of the UEs in the cell 150 is arranged in step 302. Each UE has a position index in the Q, the position index indicating the priority in the Q. In step 304, the method obtains the position index of each of at least some of the plurality of the UEs in the scheduling queue Q, e.g., the position indexes from UE0-UE5 are obtained, their position indexes are 0, 1, 2, 3, 4, 5. In step 306, the method stores the at least some of the plurality of UEs and their corresponding position indexes into a subset L, so that the UEs in the subset L have the same order of priority as they have in the scheduling queue Q. The subset L is shown in FIG. 7.

As FIG. 7 shows, the subset L comprises UE0, UE1, UE2, UE3, UE4 and UE5. The priority is from high to low from UE0 to UE5. The subset can be any proper data structure, e.g., list, buffer, etc. In step 308, for each UE in the subset L, it is determined if a current Transmission Time Interval TTI is a valid AP-SRS triggering slot for the UE U_{Li}, wherein Li is the position index of the UE U_{Li} in the scheduling queue Q. As shown in FIG. 7, each UE from UE0 to UE5 is determined if current TTI is a valid AP-SRS triggering slot. If yes, the UE U_{Li} is stored in a priority adjustment set U in step 310. If no, determine for the next UE in the subset L. Taking UE4 for example in FIG. 7, it is determined that the current TTI is a valid AP-SRS triggering slot for UE4, the UE4 is being prioritized and is U_{Li} in this example. The UE4 is stored in the priority adjustment set U.

In step 312, for each UE which has a higher priority than the UE U_{Li} in the subset L, determining if the UE is already contained in the priority adjustment set U. In the example of FIG. 7, UE0-UE3 have higher priority than UE4 in the subset L. UE0 is already contained in the priority adjustment set U, which means that UE0 has already been prioritized and does not need to be prioritized again. Then the determination goes to the next UE, that is UE1 in the subset L. In step 314, among the UEs determined not to be contained in the priority adjustment set U, obtaining a position index Lₖ of a UE U_{Lk}, wherein the UE U_{Lk} is the first UE which is not contained in the priority adjustment set U among the UEs determined not to be contained in the priority adjustment set U in the subset L. In the example in FIG. 7, UE1, UE2 and UE3 are those UEs which are not contained in U. Among these UEs, UE1 is the first one which is not contained in U. So UE1 is U_{Lk} and its position index 1 is obtained.

In step 316, for each UE from said first UE U_{Lk} to UE U_{Li-1}, down shift their position in the scheduling queue Q, respectively, wherein down shifting means moving each UE from said UE U_{Lk} to UE U_{Li-1} respectively, to the position of the next UE in the subset L, for example, U_{Lk} to the position of U_{Lk+1}, U_{Lk+1} to the position of U_{Lk+2}, U_{Li-1} to the position of U_{Li} said UE U_{Li-1} having higher priority than the UE U_{Li} and having least priority difference to the UE U_{Li} in the subset L. In the example in FIG. 7, UE1 is U_{Lk} and UE3 is U_{Li-1}, because UE 3 is the one which has a higher priority than UE4 and has least priority difference to UE4 in the subset L, that is the last UE which has a higher priority than UE4 in the subset L. From U_{Lk} UE1 to U_{Li-1} UE3, their positions are down shifted respectively in the scheduling Q. In step 318, moving the UE U_{Li} to a position corresponding to the position index Lₖ in the scheduling queue Q. In the example in FIG. 7, UE4 is moved to the position of UE1.

By this method, the UE4 which in its valid AP-SRS triggering slot is being prioritized and can be triggered successfully.

According to another embodiment, the obtaining 304 of a position index of each of at least some of the plurality of UEs 140, 142, 148 in a scheduling queue Q of the cell 150 is only performed when the UE has been configured AP-SRS and the UE's priority in the scheduling queue Q is equal to or less than a threshold Pₜₕᵣₑₛ.

By this method, only the UEs having relatively lower priority in the scheduling queue Q needs to be prioritized, so that the system burden is decreased.

According to another embodiment, the method is performed by the wireless node 130 for each TTI.

FIG. 8 shows a block diagram illustrating a prioritizing procedure of a plurality of UEs. UE0 to UE6 are arranged in a scheduling queue Q. Since UE0, UE3, UE5 have not configured AP-SRS and UE1, UE2, UE4, UE6 have configured AP-SRS, only UEs who have configured AP-SRS are obtained and stored in the subset L, i.e., UE1, UE2, UE4, UE6, in this example UE1, UE2, UE4 and UE6 have priorities lower than the threshold Pₜₕᵣₑₛ. It is determined that current TTI is a valid AP-SRS triggering slot for UE4, but invalid triggering slot for UE1, UE2, UE6, so UE4 is U_{Li}, and UE1 and UE2 which have higher priority than UE4 are considered. UE1 is the first UE which is not contained in the priority adjustment set U so UE1 is U_{Lk}. UE2 is the nearest UE to the UE4 and has a higher priority than UE4, so UE2 is U_{Li-1}. UE1 and UE2 are down shifted in the scheduling queue Q, i.e., move UE1 to position of UE2, move UE2 to position of UE4, and UE4 is moved to the original place of UE1. So that UE4 can be successfully triggered immediately in current TTI.

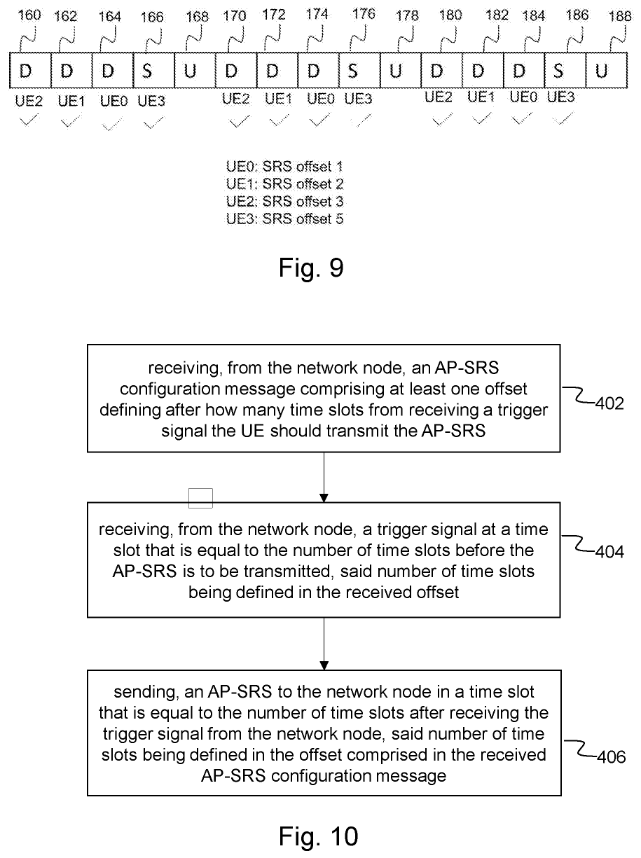

FIG. 9 shows a schematic block diagram of a frame structure of an example of a successful AP-SRS triggering schedule. After prioritizing, each UE is being placed in its valid AP-SRS triggering slot and can be triggered successfully. UE2 is triggered in slot 160 and sends AP-SRS in SRS slot 166. UE1 is triggered in slot 162 and sends AP-SRS in SRS slot 166. UE0 is triggered in slot 164 and sends AP-SRS in SRS slot 166. UE3 is triggered in slot 166 and sends AP-SRS in SRS slot 176.

Another embodiment in FIG. 10 discloses a method performed by a User Equipment UE 140 for receiving wireless signals from a network node 130 of a wireless communication network 100, the method comprising: receiving 402, from the network node 130, an AP-SRS configuration message comprising at least one offset defining after how many time slots from receiving a trigger signal the UE 140 should transmit the AP-SRS; receiving 404, from the network node 130, a trigger signal at a time slot that is equal to the number of time slots before the AP-SRS is to be transmitted, said number of time slots being defined in the received 402 offset; and sending 406, an AP-SRS to the network node 130 in a time slot that is equal to the number of time slots after receiving 404 the trigger signal from the network node 130, said number of time slots being defined in the offset comprised in the received AP-SRS configuration message.

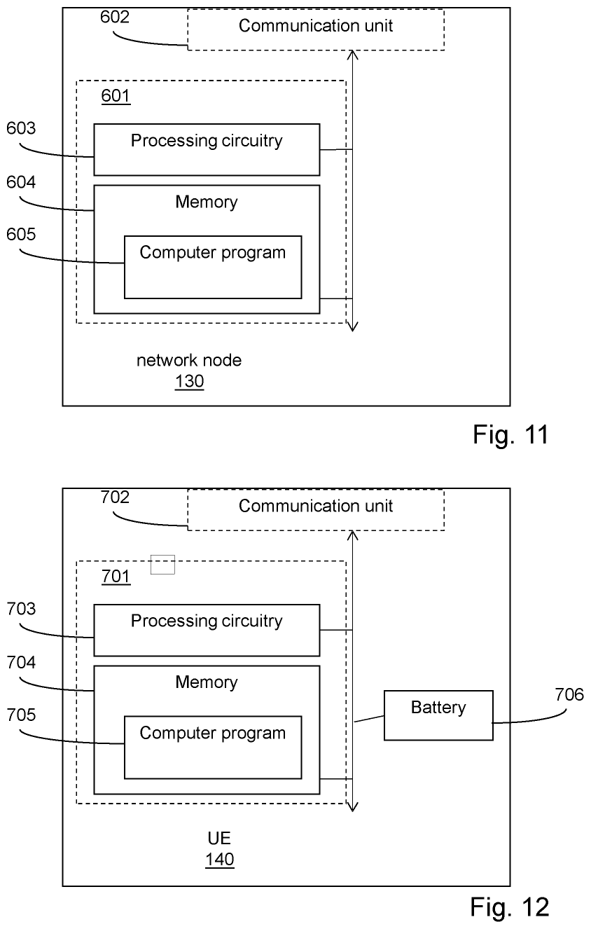

FIG. 11 discloses a block diagram of a network node 130. A network node is 130 operable in a wireless communication network 100, and configured for controlling transmission of uplink APeriodic Sounding Reference Signals, AP-SRS, the network node 130 comprising a communication unit 602, a processing circuitry 603 and a memory 604, said memory 604 containing instructions executable by said processing circuitry 603, whereby the network node 130 is operative for: sending, to each of a plurality of User Equipment, UE 140, 142, 148, an AP-SRS configuration message comprising at least one offset corresponding to each UE, said offset defining after how many time slots from receiving a trigger signal each of the plurality of UEs 140, 142, 148 should transmit the AP-SRS, said plurality of UEs 140, 142, 148 being in one and same cell 150; prioritizing, the plurality of UEs 140, 142, 148 being triggered by the trigger signals in accordance with the sent corresponding offset, thus a UE of the plurality of UEs 140, 142, 148 being prioritized, UE U_{Li}, being triggered in a valid AP-SRS triggering slot, said valid AP-SRS triggering slot is a time slot that if the trigger signal is sent to the UE U_{Li} in this slot, the UE U_{Li} will send an AP-SRS after its corresponding offset, the AP-SRS sending slot of the UE U_{Li} is an SRS slot; sending, to each of the plurality of UEs 140, 142, 148, trigger signals at time slots that are equal to the number of time slots before the AP-SRS is to be transmitted by an individual UE of the plurality of UEs 140, 142, 148; wherein the trigger signal instructing each of the plurality of UEs 140, 142, 148 to transmit AP-SRS in a time slot after its corresponding offset.

According to another embodiment, the network node is operative for the prioritizing of the plurality of UEs 140, 142, 148 being triggered by the trigger signals in accordance with the sent corresponding offset by: arranging the plurality of UEs 140, 142, 148 in a scheduling queue Q of the cell so that each UE of the plurality of UEs 140, 142, 148 have a certain position with a certain position index in the queue, the position index indicating the priority in the scheduling Q of the corresponding UE; obtaining the position index of each of at least some of the plurality of UEs 140, 142, 148 in the scheduling queue Q; storing the at least some of the plurality of UEs 140, 142, 148 and their corresponding obtained position index into a subset L, respectively, so that the UEs in the subset L have the same order of priority as they have in the scheduling queue Q; determining, for each UE in the subset L, if a current Transmission Time Interval TTI is a valid AP-SRS triggering slot for the UE U_{Li}, wherein Li is the position index of the UE U_{Li} in the scheduling queue Q; if yes, storing the UE U_{Li} in a priority adjustment set U; for each UE which has a higher priority than the UE U_{Li} in the subset L, determining if the UE is already contained in the priority adjustment set U; among the UEs determined not to be contained in the priority adjustment set U, obtaining a position index Lₖ of a UE U_{Lk}, wherein the UE U_{Lk} is the first UE which is not contained in the priority adjustment set U among the UEs determined not to be contained in the priority adjustment set U in the subset L; for each UE from said first UE U_{Lk} to UE U_{Li-1}, down shifting their position in the scheduling queue Q, respectively, wherein down shifting means moving each UE from said UE U_{Lk} to UE U_{Li-1} respectively, to the position of the next UE in the subset L, for example, UE U_{Lk} to the position of UE U_{Lk+1}, UE U_{Lk+1} to the position of UE U_{Lk+2}, UE U_{Li-1} to the position of UE U_{Li}, said UE U_{Li-1} having higher priority than the UE U_{Li} and having least priority difference to the UE U_{Li} in the subset L; moving the UE U_{Li} to a position corresponding to the position index Lₖ in the scheduling queue Q.

According to another embodiment, the obtaining of a position index of each of at least some of the plurality of UEs 140, 142, 148 in a scheduling queue Q of the cell (150) is only performed when the UE has been configured AP-SRS, and the UE's priority in the scheduling queue Q is equal to or less than a threshold Pₜₕᵣₑₛ.

According to another embodiment in FIG. 11, the network node 130 may further comprise a communication unit 602, which may be considered to comprise conventional means for wireless communication with the UEs 140, 142, 148, such as a transceiver for wireless transmission and reception of signals. The instructions executable by said processing circuitry 603 may be arranged as a computer program 605 stored e.g., in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the method mentioned above. The processing circuitry 603 may comprise one or more programmable processors, application-specific integrated circuits, field programmable gate arrays or combinations of these adapted to execute instructions.

The computer program 605 may be arranged such that when its instructions are run in the processing circuitry, they cause the network node 130 to perform the steps described in any of the described exemplary embodiments of the network node 130 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g., a CD, DVD or flash memory, from which the program could be downloaded into the memory 604. Alternatively, the computer program may be stored on a server or any other entity to which the network node 130 has access via the communication unit 602. The computer program 605 may then be downloaded from the server into the memory 604.

According to another embodiment of FIG. 12, a User Equipment UE 140 operable in a wireless communication network 100 and configured for receiving wireless signals from a network node 130 of the wireless communication network 100, the UE 140 comprising a processing circuitry 703 and a memory 704, said memory 704 containing instructions executable by said processing circuitry 703, whereby the UE 140 is operative for: receiving, from the network node 130, an AP-SRS configuration message comprising at least one offset defining after how many time slots from receiving a trigger signal the UE 140 should transmit the AP-SRS; receiving, from the network node 130, a trigger signal at a time slot that is equal to the number of time slots before the AP-SRS is to be transmitted, said number of time slots being defined in the received offset; and sending, an AP-SRS to the network node 130 in a time slot that is equal to the number of time slots after receiving the trigger signal from the network node 130, said number of time slots being defined in the offset comprised in the received AP-SRS configuration message.

According to another embodiment in FIG. 12, the UE 140 may further comprise a communication unit 702, which may be considered to comprise conventional means for wireless communication with the network node 130, such as a transceiver for wireless transmission and reception of signals. The instructions executable by said processing circuitry 703 may be arranged as a computer program 705 stored e.g., in said memory 704. The processing circuitry 703 and the memory 704 may be arranged in a sub-arrangement 701. The sub-arrangement 701 may be a micro-processor and adequate software and storage therefore, a Programmable Logic Device, PLD, or other electronic component(s)/processing circuit(s) configured to perform the method mentioned above. The processing circuitry 703 may comprise one or more programmable processors, application-specific integrated circuits, field programmable gate arrays or combinations of these adapted to execute instructions.

The computer program 705 may be arranged such that when its instructions are run in the processing circuitry, they cause the UE 140 to perform the steps described in any of the described exemplary embodiments of UE 140 and its method. The computer program 705 may be carried by a computer program product connectable to the processing circuitry 703. The computer program product may be the memory 704, or at least arranged in the memory. The memory 704 may be realized as for example a RAM (Random-access memory), ROM (Read-Only Memory) or an EEPROM (Electrical Erasable Programmable ROM). In some embodiments, a carrier may contain the computer program 705. The carrier may be one of an electronic signal, an optical signal, an electromagnetic signal, a magnetic signal, an electric signal, a radio signal, a microwave signal, or computer readable storage medium. The computer-readable storage medium may be e.g., a CD, DVD or flash memory, from which the program could be downloaded into the memory 704. Alternatively, the computer program may be stored on a server or any other entity to which the UE 140 has access via the communication unit 702. The computer program 705 may then be downloaded from the server into the memory 704.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a network node of a wireless communication network, for controlling transmission of uplink APeriodic Sounding Reference Signals, AP-SRS, the method comprising:
sending, to each of a plurality of User Equipment, UE, an AP-SRS configuration message comprising at least one offset corresponding to each UE, said offset defining after how many time slots from receiving a trigger signal each of the plurality of UEs should transmit the AP-SRS, said plurality of UEs being in one and same cell;
prioritizing, the plurality of UEs being triggered by the trigger signals in accordance with the sent corresponding offset, thus a UE of the plurality of UEs being prioritized, UE ULi, being triggered in a valid AP-SRS triggering slot, said valid AP-SRS triggering slot is a time slot that if the trigger signal is sent to the UE ULi in this slot, the UE ULi will send an AP-SRS after its corresponding offset, the AP-SRS sending slot of the UE ULi is an SRS slot;
sending, to each of the plurality of UEs, trigger signals at time slots that are equal to the number of time slots before the AP-SRS is to be transmitted by an individual UE of the plurality of UEs; wherein
the trigger signals instructing each of the plurality of UEs to transmit the AP-SRS in a time slot after its corresponding offset.

2. The method as claimed in claim 1, wherein said prioritizing of the plurality of UEs being triggered by the trigger signals in accordance with the sent corresponding offset further comprises:
arranging the plurality of UEs in a scheduling queue Q of the cell so that each UE of the plurality of UEs has a certain position with a certain position index in the queue, the position index indicating the priority in the scheduling queue Q of the corresponding UE;
obtaining the position index of each of at least some of the plurality of UEs in the scheduling queue Q;
storing the at least some of the plurality of UEs and their corresponding obtained position index into a subset L, respectively, so that the UEs in the subset L have the same order of priority as they have in the scheduling queue Q;
determining, for each UE in the subset L, if a current Transmission Time Interval TTI is a valid AP-SRS triggering slot for the UE ULi, wherein Li is the position index of the UE ULi in the scheduling queue Q;
if yes, storing the UE ULi in a priority adjustment set U;
for each UE which has a higher priority than the UE ULi in the subset L, determining if the UE is already contained in the priority adjustment set U;
among the UEs determined not to be contained in the priority adjustment set U, obtaining a position index Lk of a UE ULk, wherein the UE ULk is the first UE which is not contained in the priority adjustment set U among the UEs determined not to be contained in the priority adjustment set U in the subset L;
for each UE from said first UE ULk to UE ULi−1, down shifting their position in the scheduling queue Q, respectively, wherein down shifting means moving each UE from said UE ULk to UE ULi−1 respectively, to the position of the next UE in the subset L, for example, UE ULk to the position of UE ULk+1, UE ULk+1 to the position of UE ULk+2, UE ULi−1 to the position of UE ULi, said UE ULi−1 having higher priority than the UE ULi and having least priority difference to the UE ULi in the subset L;
moving the UE ULi to a position corresponding to the position index Lk in the scheduling queue Q.

3. The method as claimed in claim 2, wherein the obtaining of a position index of each of at least some of the plurality of UEs in a scheduling queue Q of the cell is only performed when the UE has been configured AP-SRS and the UE's priority in the scheduling queue Q is equal to or less than a threshold Pthres.

4. The method as claimed in claim 1, wherein said method is performed by the wireless node for each TTI.

5. A method performed by a User Equipment UE for receiving wireless signals from a network node of a wireless communication network, the method comprising:
receiving, from the network node, an AP-SRS configuration message comprising at least one offset defining after how many time slots from receiving a trigger signal the UE should transmit the AP-SRS;
receiving, from the network node, a trigger signal at a time slot that is equal to the number of time slots before the AP-SRS is to be transmitted, said number of time slots being defined in the received offset; and
sending, an AP-SRS to the network node in a time slot that is equal to the number of time slots after receiving the trigger signal from the network node, said number of time slots being defined in the offset comprised in the received AP-SRS configuration message.

6. A network node operable in a wireless communication network, and configured for controlling transmission of uplink APeriodic Sounding Reference Signals, AP-SRS, the network node comprising a communication unit, a processing circuitry and a memory, said memory containing instructions executable by said processing circuitry, whereby the network node is operative for:
sending, to each of a plurality of User Equipment, UE, an AP-SRS configuration message comprising at least one offset corresponding to each UE, said offset defining after how many time slots from receiving a trigger signal each of the plurality of UEs should transmit the AP-SRS, said plurality of UEs being in one and same cell;
prioritizing, the plurality of UEs being triggered by the trigger signals in accordance with the sent corresponding offset, thus a UE of the plurality of UEs being prioritized, UE ULi, being triggered in a valid AP-SRS triggering slot, said valid AP-SRS triggering slot is a time slot that if the trigger signal is sent to the UE ULi in this slot, the UE ULi will send an AP-SRS after its corresponding offset, the AP-SRS sending slot of the UE ULi is an SRS slot;
sending, to each of the plurality of UEs, trigger signals at time slots that are equal to the number of time slots before the AP-SRS is to be transmitted by an individual UE of the plurality of UEs; wherein
the trigger signal instructing each of the plurality of UEs to transmit AP-SRS in a time slot after its corresponding offset.

7. The Network node according to claim 6, wherein the network node is operative for the prioritizing of the plurality of UEs being triggered by the trigger signals in accordance with the sent corresponding offset by:
arranging the plurality of UEs in a scheduling queue Q of the cell so that each UE of the plurality of UEs have a certain position with a certain position index in the queue, the position index indicating the priority in the scheduling Q of the corresponding UE;
obtaining the position index of each of at least some of the plurality of UEs in the scheduling queue Q;
storing the at least some of the plurality of UEs and their corresponding obtained position index into a subset L, respectively, so that the UEs in the subset L have the same order of priority as they have in the scheduling queue Q;
determining, for each UE in the subset L, if a current Transmission Time Interval TTI is a valid AP-SRS triggering slot for the UE ULi, wherein Li is the position index of the UE ULi in the scheduling queue Q;
if yes, storing the UE ULi in a priority adjustment set U;
for each UE which has a higher priority than the UE ULi in the subset L, determining if the UE is already contained in the priority adjustment set U;
among the UEs determined not to be contained in the priority adjustment set U, obtaining a position index Lk of a UE ULk, wherein the UE ULk is the first UE which is not contained in the priority adjustment set U among the UEs determined not to be contained in the priority adjustment set U in the subset L;
for each UE from said first UE ULk to UE ULi−1, down shifting their position in the scheduling queue Q, respectively, wherein down shifting means moving each UE from said UE ULk to UE ULi−1 respectively, to the position of the next UE in the subset L, for example, UE ULk to the position of UE ULk+1, UE ULk+1 to the position of UE ULk+2, UE ULi−1 to the position of ULi, said UE ULi−1 having higher priority than the UE ULi and having least priority difference to the UE ULi in the subset L, and
moving the UE ULi to a position corresponding to the position index Lk in the scheduling queue Q.

8. The Network node as claimed in claim 7, operative for only performing the obtaining of a position index of each of at least some of the plurality of UEs in a scheduling queue Q of the cell when the UE has been configured the AP-SRS and the UE's priority in the scheduling queue Q is equal to or less than a threshold Pthres.

9. A User Equipment UE operable in a wireless communication network and configured for receiving wireless signals from a network node of the wireless communication network, the UE comprising a processing circuitry and a memory, said memory containing instructions executable by said processing circuitry, whereby the UE is operative for:
receiving, from the network node, an AP-SRS configuration message comprising at least one offset defining after how many time slots from receiving a trigger signal the UE should transmit the AP-SRS;
receiving, from the network node, a trigger signal at a time slot that is equal to the number of time slots before the AP-SRS is to be transmitted, said number of time slots being defined in the received offset; and
sending, an AP-SRS to the network node in a time slot that is equal to the number of time slots after receiving the trigger signal from the network node, said number of time slots being defined in the offset comprised in the received AP-SRS configuration message.

10.-13. (canceled)
